(19) United States
(12) Patent Application Publication
(10) Pub. No.: US 2008/0119991 A1
(43) Pub. Date: May 22, 2008

(54) Communication device and passive safety device

(75) Inventor: Hiroshi Hattori, Chita-gun (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/983,951

(22) Filed: Nov. 13, 2007

(30) Foreign Application Priority Data
Nov. 17, 2006 (JP) 2006-311467

(51) Int. Cl. B60R 21/01; H02J 9/00

(52) U.S. Cl. 701/45; 307/64; 701/36

(57) ABSTRACT

A communication device for securing a capacity of a backup power supply is provided. The communication device is connected to a power supply and a backup power supply, and communicates according to a CAN protocol. An air bag system has a battery, a booster circuit, a backup power supply, a microcomputer, and an IC for air bag control. The IC for air bag control includes a power supply interruption detection circuit unit, a mode switching circuit unit, and a CAN transceiver circuit unit. When the booster circuit is interrupted, the power supply interruption detection circuit unit will output a STDBY0 signal, and the mode switching circuit unit will output a mode switching signal. When receiving the mode switching signal, the CAN transceiver circuit unit will switch to stand-by mode in which power consumption is lower. By the present switching, it is possible to suppress the power consumption of the CAN transceiver circuit unit at the time of backup. Therefore, the capacity of the backup power supply can be ensured.

### CROSS REFERENCE TO RELATED APPLICATIONS

The present invention is based on and claims priority to unpublished Japanese Patent Application No. 2006-311467 the contents of which are incorporated herein by reference.

### BACKGROUND OF THE INVENTION

1. Field of the Invention

The present invention relates to a communication device in a network, and more specifically to a communication device for communicating in the network according to a predetermined protocol.

2. Description of Background Art

Conventional communication devices that communicate according to predetermined protocols such as a Controller Area Network (CAN) protocol, include a CAN controller and a CAN transceiver as described, for example, in JP 2002-73430A and JP 2002-94535A, respectively. The CAN devices described therein are communication devices each of which communicate according to the CAN protocol and each of which can be used in various applications including vehicle systems such as an air bag system. In one example, an air bag system can communicate with other control devices in a vehicle according to the CAN protocol and thereby share various information. It should be noted that the typical air bag system has a battery, a booster circuit for boosting the battery voltage, and a backup power supply charged by the booster circuit. When wiring between the air bag system and the battery is cut off, for example at the time of vehicle collision, electric power can be supplied from the backup power supply in place of the battery and the booster circuit. The backup power supply is used to set each unit of the air bag system into operation and to inflate an air bag. Therefore, in order to reliably inflate the air bag, the backup power supply must secure a sufficient capacity prior to any incident requiring deployment.

In the air bag systems using the devices described above, however, even when wiring with a battery is cut off and the system is reduced to operating in a backup state, for example in which the backup power supply supplies electric power, the CAN transceiver continues to convert the signal although conversion is unnecessary. Consequently, the CAN transceiver consumes the same electric power as if in a normal state thereby reducing the capacity of the backup power supply to supply power to the airbag system components.

### SUMMARY OF THE INVENTION

The present invention contemplates the above described situation, and it is therefore an object of the present invention to provide a communication device that is connected to a power supply and a backup power supply and communicates according to a CAN protocol, and that can secure a capacity of the backup power supply.

Vigorous research was carried out resulting in the concept that the fullest capacity of the backup power supply can be ensured by suppressing power consumption of a conversion circuit unit at the time that backup is necessitated.

An exemplary communication device therefore is characterized by having: a power supply; a backup power supply that is charged by the power supply and, when the power supply is interrupted, supplies electric power in place of the power supply; a conversion circuit unit that is connected to the power supply and the backup power supply, that mutually converts signals of different forms, and, when receiving the mode switching signal, that switches to a low power consumption mode in which the power consumption is lower; mode switching means for outputting a mode switching signal when detecting that the power supply is interrupted; and a microcomputer for communicating with external devices through the conversion circuit unit according to a predetermined protocol.

With above noted configuration, the power consumption of the conversion circuit unit can be suppressed at the time of backup and the capacity of the backup power supply can thereby be ensured. When the power supply is interrupted, the air bag system enters a backup state in which the backup power supply supplies electric power in place of the power supply. When in the backup state, the mode switching means outputs the mode switching signal. When receiving the mode switching signal, the conversion circuit unit will switch to the low power consumption mode in which power consumption is lower than during normal operation and the power consumption of the conversion circuit unit can be suppressed at the time of backup. Accordingly, the capacity of the backup power supply can be ensured.

An exemplary communication device can be further characterized in that the conversion circuit unit mutually converts a differential voltage signal and a digital signal, and the microcomputer communicates according to the CAN protocol.

An exemplary communication device can be further characterized in that the mode switching means is constructed with a circuit, such as a dedicated mode switching circuit, such that the mode switching signal can be outputted with certainty.

An exemplary communication device can be further characterized in that the mode switching means is constructed using a program in the microcomputer such as a computer software program, program product, instructions, article of manufacture, or the like as would be appreciated by one of ordinary skill. In accordance with the present embodiments and other embodiments described herein, a program can be embodied, for example, as a series of instructions carried on a computer readable medium, which, when read and executed for example by the microcomputer can cause certain useful actions to occur. With the above noted configuration, the mode switching signal can be outputted with certainty. Moreover, since, in the present embodiment, a dedicated mode switching circuit made up of hardware is unnecessary, the size and cost of the communication device can be reduced.

An exemplary communication device can be further characterized by having: a power supply; a backup power supply that is charged by the power supply and, when the power supply is interrupted, supplies electric power in place of the power supply; a conversion circuit unit that is connected to the power supply and the backup power supply, and mutually converts signals of different forms, and, when receiving a mode switching signal, switches to the low power consumption mode in which the power consumption is lower; power supply interruption detecting means for outputting a first control signal when detecting that the power supply is interrupted; a microcomputer that communicates with external devices according to a predetermined protocol through the conversion circuit unit and, when the conversion circuit unit is not in use, outputs a second control signal; and mode switching means for outputting the mode switching signal when at least either the first control signal or the second control signal is outputted.

With the above noted configuration, the power consumption of the conversion circuit unit can be suppressed at the time of backup and the capacity of the backup power supply can be ensured. Moreover, even during a time other than the time of backup, the power consumption of the conversion circuit unit can be suppressed if the conversion circuit unit is not being used. When the power supply is interrupted, the communication device enters the backup state in which the backup power supply supplies electric power in place of the power supply. If the communication device enters the backup state, power supply interruption detecting means outputs the first control signal and mode switching means outputs a mode switching signal. Upon receiving the mode switching signal, the conversion circuit unit switches to the low power consumption mode and the power consumption of the conversion circuit unit can thereby be suppressed at the time of backup. Accordingly, the capacity of the backup power supply can be ensured.

It should be noted that, in the present case, when not using the conversion circuit unit, the microcomputer outputs the second control signal and the mode switching means outputs the mode switching signal. Therefore, even during times not associated with the backup state, the power consumption of the conversion circuit unit can be suppressed if conversion circuit unit is not in use. By way of the above noted feature, the conversion circuit unit can be used only when necessary while suppressing power consumption when use is not necessary.

An exemplary communication device can further be characterized in that the conversion circuit unit mutually converts the differential voltage signal and the digital signal and the microcomputer communicates according to the CAN protocol.

An exemplary communication device can further be characterized in that each of the power supply interruption detecting means and the mode switching means is constructed with a circuit, such as a dedicated circuit such that a mode switching signal can be outputted with certainty.

An exemplary communication device can further be characterized in that each of the power supply interruption detecting means and the mode switching means is constructed with a program executed by the microcomputer, for example, as described herein above and as will be described in greater detail herein below. With the above noted configuration, the mode switching signal can be outputted with certainty. Moreover, since a switching circuit made up of hardware is unnecessary, the size and cost of the communication device can be reduced.

An exemplary communication device can further be characterized in that, when a switch is made to the low power consumption mode, the conversion circuit unit halts output of the differential voltage signal. With the above noted configuration, output of an unstable differential voltage signal at the time of voltage lowering of the backup power supply can be suppressed.

An exemplary communication device can further be characterized in that the microcomputer controls passive safety means for vehicle that is connected to the power supply and the backup power supply. With the above noted configuration, the capacity of the backup power supply can be ensured at the time of backup, and the passive safety means for vehicle can be made to operate more stably.

An exemplary communication device can further be characterized as substantially constructed of the communication device previously described and passive safety means for vehicle that is connected to the power supply and the backup power supply. When the power supply is interrupted the communication device can be driven by the backup power supply. With the above noted configuration, the power consumption can be suppressed at the time of backup. Therefore, the capacity of the backup power supply can be ensured.

It should be noted that the terms first and second control signals, as used in the present specification, are introduced for convenience, in order to distinguish control signals and should not be considered limiting.

### BRIEF DESCRIPTION OF THE DRAWINGS

FIG. 1 is a circuit diagram illustrating an exemplary air bag system in accordance with a first embodiment; and

FIG. 2 is a circuit diagram illustrating an exemplary air bag system in accordance with a second embodiment.

### DETAILED DESCRIPTION OF THE EMBODIMENTS

Next, embodiments will be enumerated and the present invention will be described in more detail, for example, with particular reference to the above described drawings. These embodiments show examples in which communication devices according to the present invention are applied to an air bag system. Although the described embodiments are contemplated as representative of various aspects of the invention, they are illustrative and exemplary in nature.

### First Embodiment

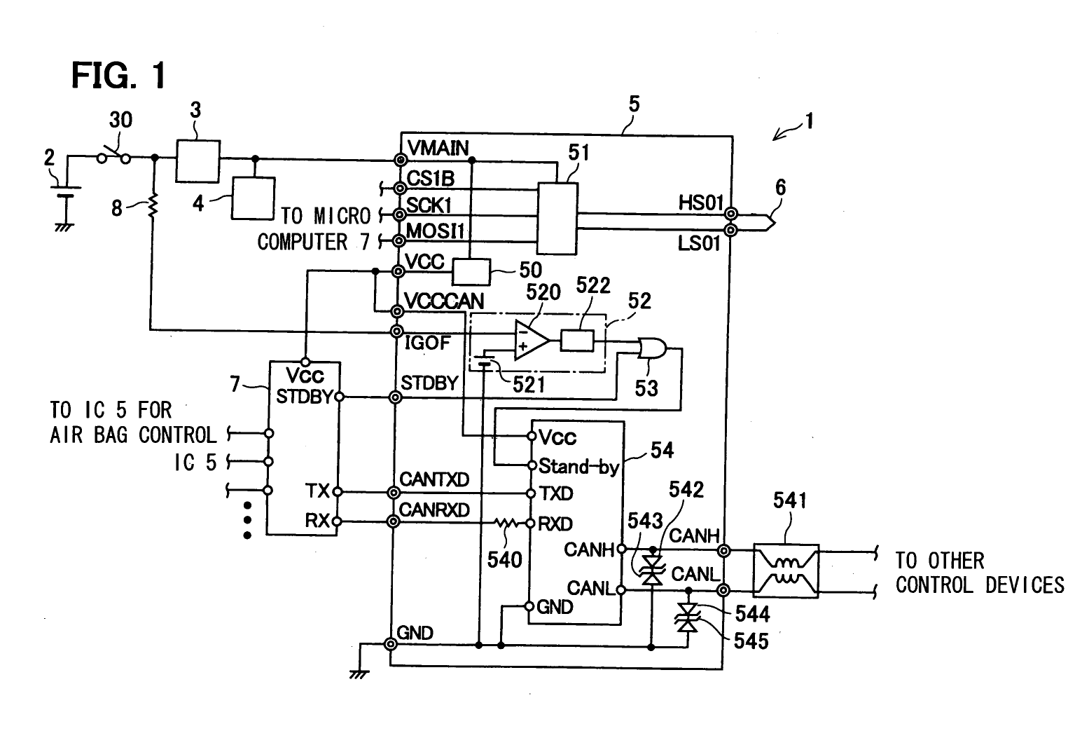

With reference to FIG. 1, a configuration of an exemplary air bag system will be described in accordance with a first embodiment.

As shown, an air bag system 1 including, for example, a communication device and a passive safety device has a fundamental construction including a battery 2 forming a power supply, a booster circuit 3 also forming a power supply or part of a power supply, a backup power supply 4, an integrated circuit (IC) 5, an air bag activation device such as a squib 6 associated with a activating a passive safety means for the vehicle, and a microcomputer 7.

The battery 2 is a secondary battery for outputting a direct current voltage. The booster circuit 3 is a circuit for boosting the output voltage of the battery 2 and thus forms at least a portion of the power supply associated with the battery 2 or alternatively can be considered independently as a power supply. An input terminal of the booster circuit 3 is connected to a positive-electrode terminal of the battery 2 through an ignition switch 30. A negative-electrode terminal of the battery 2 is grounded to a vehicle body. Moreover, an output terminal of the booster circuit 3 is connected to the IC 5.

The backup power supply 4 can be a circuit having a charge storage device such as, for example, a capacitor that is charged by the booster circuit 3. When an output voltage of the booster circuit 3 is interrupted the capacitor or charge storage device supplies power in place of the battery 2 and the booster circuit 3. The backup power supply 4 is connected to the output terminal of the booster circuit 3 in order to be charged and is further connected to the IC 5 in order to supply electric power in place of the battery 2 and the booster circuit 3, for example, when power is interrupted.

The IC 5 supplies an ignition current to the squib 6 based on an ignition signal output by the microcomputer 7. Moreover, IC 5 mutually converts a differential voltage signal and a digital signal between the microcomputer 7 and other control devices as will be described in greater detail hereinafter. The IC 5 can be constructed of various portions, cells, modules, or the like as will be appreciated by one of ordinary skill, including a power supply circuit unit 50 for providing control, an ignition circuit unit 51, a power supply interruption detection circuit unit 52, a mode switching circuit unit 53, and a Controller Area Network (CAN) transceiver circuit unit 54.

The power supply circuit unit 50 supplies electric power as VCC in order to operate the IC 5 and the microcomputer 7 as will be described. An input terminal of the power supply circuit unit 50 is connected to the output terminal of the booster circuit 3 and the backup power supply 4 through a VMAIN terminal, which is also connected to the ignition circuit 51 as will be further described. The output terminal of power supply circuit unit 50 provides an external VCC output terminal that provides a VCC power supply to the microcomputer 7 and further has a loop back connection to an external VCCCAN terminal to provide power to additional internal components as will be further described.

The ignition circuit unit 51 supplies an ignition current to the squib 6 based on an ignition signal output by the microcomputer 7. The squib 6 is ignited by the ignition current and inflates the air bag, passive safety means, or the like for the vehicle. Since a passive safety device, such as an airbag, is well known in the art, a figure thereof has been omitted for simplicity. A power supply terminal of the ignition circuit unit 51 is connected to the output terminal of the booster circuit 3 and the backup power supply 4 through the VMAIN terminal as described above in regard to power supply circuit 50. In the present example, input terminals such as a CS1B terminal, an SCK1 terminal, and a MOSI1 terminal can be connected to the microcomputer 7. The microcomputer 7 can be connected to the squib 6 through, for example, an HS01 terminal and an LS01 terminal.

As shown, power supply interruption detection circuit unit 52 outputs a first control signal such as a STDBY0 signal when the battery 2 is cut off and the output voltage of the booster circuit 3 is interrupted. The power supply interruption detection circuit unit 52 includes a comparator 520, a threshold reference supply 521, and a delay circuit 522. A positive or non-inverting input terminal of the comparator 520 is connected to a positive-electrode terminal of the threshold reference power supply 521. A negative-electrode terminal of the threshold reference power supply 521 is grounded to the vehicle body through a GND terminal. A negative or inverting input terminal of the comparator 520 is connected to an IGOF terminal and connected to the input terminal of the booster circuit 3 through a resistor 8. The output terminal of the comparator 520 is connected to an input terminal of the delay circuit 522. An output terminal of the delay circuit 522 is connected to the mode switching circuit unit 53.

When at least either the STDBY0 signal or a STDBY1 signal is outputted, the mode switching circuit unit 53 outputs a mode switching signal to control for example, the standby mode. The mode switching circuit unit 53 can be constructed, for example, with an OR circuit or gate. One input terminal of the mode switching circuit 53 is connected to the output terminal of the power supply interruption detection circuit unit 52 as noted, or, more specifically, to the output terminal of the delay circuit 522. The other input terminal is connected to the microcomputer 7 through a STDBY terminal. An output terminal of the mode switching circuit 53 is connected to the stand-by input of the CAN transceiver circuit unit 54.

The CAN transceiver circuit unit 54 converts and serially outputs the inputted differential voltage signal. The differential voltage signal is converted into a digital signal and is serially output. Also, the serially inputted digital signal is converted into a differential voltage signal and is outputs. Moreover, when receiving the mode switching signal, CAN transceiver circuit unit 54 switches to a stand-by mode, which can be referred to as a low power consumption mode, in which power consumption is relatively lower than operation in the non stand-by mode.

The CAN transceiver circuit unit 54 is equipped with the Vcc terminal from which electric power for operation is supplied as previously noted and a GND terminal. Moreover, it is equipped with a Stand-by terminal into which the mode switching signal is inputted. When the mode switching signal is inputted into the Stand-by terminal, the CAN transceiver circuit unit 54 will switch to the stand-by mode in which the power consumption is lower than that at the time of the usual operation, and will halt output of the differential voltage signal. Furthermore, the CAN transceiver circuit unit 54 is equipped with an RXD terminal and a TXD terminal through which the digital signal is serially inputted/outputted, respectively.

The CAN transceiver circuit unit 54 is further equipped with a CANH terminal and a CANL terminal for outputting and inputting the differential voltage signal, respectively. The Vcc terminal of the CAN transceiver circuit unit 54 is connected to the output terminal of the power supply circuit unit 50 for control through the VCCCAN terminal and the VCC terminal of the IC 5. The Stand-by terminal is connected to the output terminal of the mode switching circuit unit 53. The TXD terminal is connected to the microcomputer 7 through a CANTXD terminal of the IC 5. The RXD terminal is connected to the microcomputer 7 through a resistor 540 and a CANRXD terminal of the IC 5. The CANH terminal and the CANL terminal of the CAN transceiver circuit unit 54 are connected to a respective external CANH terminal and CANL terminal of the IC 5 for communication of the differential voltage signal. The external CANH terminal and CANL terminal are connected to other control devices through a choke coil 541. Moreover, the lines CANL and CANH lines are grounded to the vehicle body through zener diodes 542 to 545 and a GND terminal of the IC 5. The GND terminal is grounded to the vehicle body through the GND terminal of the IC 5.

The microcomputer 7 communicates with other control devices (not shown) carried on the vehicle and capable of operating according to the CAN protocol to exchange information, and also determines ignition timing based on an output of an acceleration sensor (not shown) installed in the vehicle, and outputs the ignition signal for controlling the ignition circuit unit. The microcomputer 7 is equipped with a TX terminal for serially outputting a digital signal and an RX terminal for serially inputting a digital signal. Moreover, the microcomputer 7 is equipped with the STDBY terminal for outputting a second control signal such as the STDBY1 signal when not using the conversion circuit unit such as the CAN transceiver circuit unit 54. The TX terminal, the RX terminal, and the STDBY terminal are connected to a CANTXD terminal, the CANRXD terminal, and the STDBY terminal of the IC 5, respectively. Furthermore, the microcomputer 7 is equipped with output terminals for outputting the ignition signal. The output terminals can be connected, for example, to the CS1B terminal, the SCK1 terminal, and the MOSI1 terminal of the IC 5.

Next, with reference sill to FIG. 1, the operation of the air bag system 1 will be explained in accordance with various exemplary embodiments. For example, when the ignition switch 30 is turned on, the battery 2 will be connected to the booster circuit 3. The booster circuit 3 boosts the output voltage of the battery 2, and outputs the boosted voltage. The backup power supply 4 is charged by the booster circuit 3. Moreover, the IC 5 and the microcomputer 7 are supplied with electric power from the power supply circuit unit 50 and can begin operation. When the IC 5 operates, the microcomputer 7 will communicate with other control devices according to the CAN protocol to exchange information. If the vehicle collides, the microcomputer 7 will output the ignition signal based on an output of the acceleration sensor. When the battery 2 is cut off, the output voltage of the booster circuit 3 will be interrupted. However, the IC 5 can operate without interruption since it is supplied with electric power from the backup power supply 4. When the voltage of the IGOF terminal becomes smaller than the voltage of the threshold reference supply 521, the power supply interruption detection circuit unit 52 will detect interruption of the output voltage of the booster circuit 3, and will output the STDBY0 signal (not shown) as described above. When the STDBY0 signal is outputted, the mode switching circuit unit 53 will output the mode switching signal. The CAN transceiver circuit unit 54 switches to the stand-by mode by receiving the mode switching signal, and halts output of the differential voltage signal. Therefore, the power consumption of the CAN transceiver circuit unit 54 is suppressed, and the capacity of the backup power supply 4 can be ensured. Moreover, output of an unstable differential voltage signal of the backup power supply 4 at the time of voltage lowering can be suppressed. The ignition circuit unit 51 is supplied with electric power from the backup power supply 4, and receives the ignition signal, and thereby supplies the ignition current to the squib 6. As described above, since the capacity of the backup power supply 4 is being ensured, it can supply a sufficient ignition current for the squib 6. The squib 6 is ignited by the ignition current flowing in it, inflates an air bag, and protects the occupant of a vehicle.

The microcomputer 7 outputs the STDBY1 signal (not shown) when not using the CAN transceiver circuit unit 54. When the STDBY1 signal is outputted, the mode switching circuit unit 53 will output the mode switching signal. The CAN transceiver circuit unit 54 switches to the stand-by mode by receiving the mode switching signal, and halts output of the differential voltage signal. Therefore, even when being not supplied with electric power from the backup power supply 4, the power consumption of the CAN transceiver circuit unit 54 can be suppressed.

Finally, an effect of the invention in accordance with the first and various exemplary embodiments will be explained. According to the first embodiment, in a backup state where the output voltage of the booster circuit 3 is interrupted and the backup power supply 4 supplies electric power, the power consumption of the CAN transceiver circuit unit 54 can be suppressed. Therefore, the capacity of the backup power supply 4 can be ensured and it is accordingly possible to reliably set the air bag into operation. Moreover, the power consumption of the CAN transceiver circuit unit 54 can be reduced when not in use, even when no electric power is supplied from the backup power supply 4. Therefore the IC 5 can be used, regardless of whether a necessity exists to communicate with other control devices, while reducing unnecessary power consumption. Furthermore, a capacitance requirement of the backup power supply can be reduced resulting in reduced size and cost thereof.

Moreover, according to the first embodiment, the voltage interruption detection circuit unit 52 and the mode switching circuit unit 53 are constructed with hardware so as to ensure that the mode switching signal can be reliably outputted.

Furthermore, according to the first embodiment, since the output of the differential voltage signal is halted when the output voltage of the booster circuit 3 is interrupted and the backup power supply 4 supplies electric power, the output of an unstable differential voltage signal at the time of voltage lowering of the backup power supply 4 can be reduced or prevented.

### Second Embodiment

Next, an air bag system of a second exemplary embodiment will be described. The air bag system of the second embodiment does not use the STDBY1 signal as provided by microcomputer 7 in the air bag system of the first embodiment. In the second exemplary embodiment, the microcomputer 11 and the IC 10 in connection with it are altered somewhat as compared to the first embodiment.

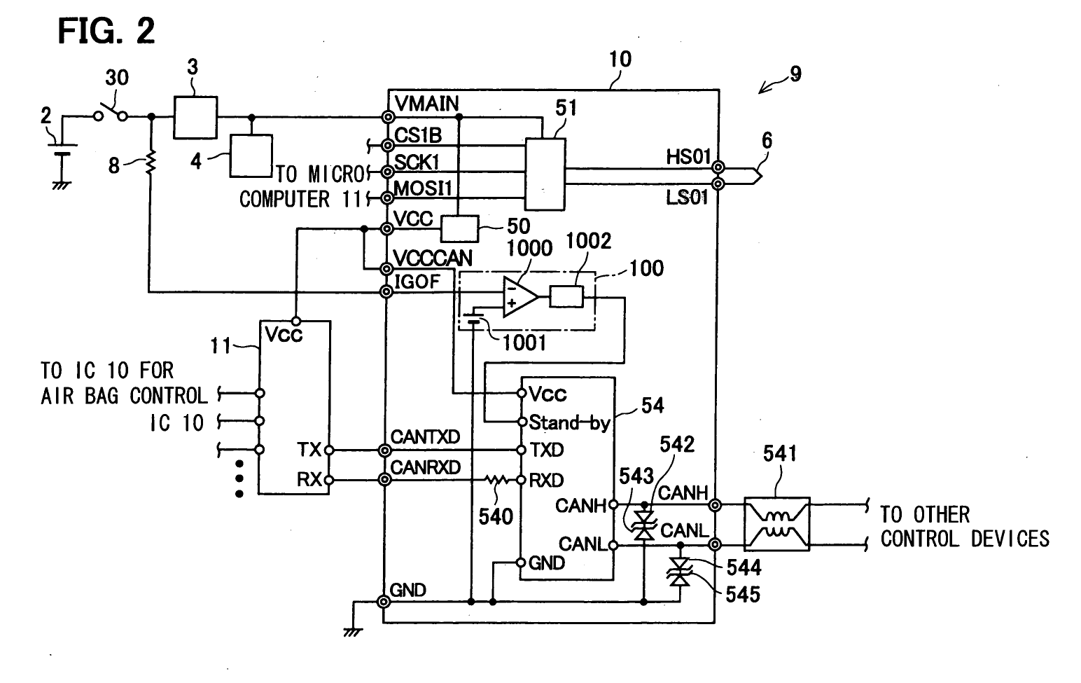

With reference to FIG. 2, a configuration of an exemplary air bag system 9 will be explained. In the following description it should be noted that the configuration of the microcomputer 11 and the IC 10 will be explained where different from the air bag system of the first embodiment. Parts common to the first and second embodiments will be omitted except where necessary to complete the explanation. In addition, explanation is provided using the same reference numerals as the corresponding elements from the first embodiment where no substantive differences are present.

The air bag system 9 such as includes, for example, a communication device, a passive safety device, or the like is constructed, for example, of a power supply such as the battery 2, an additional power supply or additional portion of the previously noted power supply, such as the booster circuit 3, the backup power supply 4, an IC 10, the squib 6, and a microcomputer 11.

Unlike the microcomputer 7 in the first embodiment, the microcomputer 11 is not equipped with a STDBY terminal and does not output a STDBY1 signal.

The IC 10 can be constructed of the power supply circuit unit 50 for control, the ignition circuit unit 51, the mode switching circuit unit 100, and the CAN transceiver circuit unit 54. The mode switching circuit unit 100 outputs the mode switching signal when the battery 2 is cut off and the output voltage of the booster circuit 3 is interrupted. The mode switching circuit unit 100 can include a comparator 1000, a threshold reference supply 1001, and a delay circuit 1002. A positive or non-inverting input terminal of the comparator 1000 is connected to a positive-electrode terminal of the threshold reference supply 1001. A negative-electrode terminal of the threshold reference supply 1001 is grounded to the vehicle body through a GND terminal. An inverting or negative input terminal of the comparator 1000 is connected to the IGOF terminal and connected to the input terminal of the booster circuit 3 through the resistor 8. The output terminal of comparator 1000 is connected to an input terminal of the delay circuit 1002. An output terminal of the delay circuit 1002 is connected to the Stand-by terminal of the CAN transceiver circuit unit 54.

Next, with reference still to FIG. 2, the operation of the air bag system 10 in accordance with various exemplary embodiments will be explained. When the ignition switch 30 turns on, the booster circuit 3 boosts the output voltage of the battery 2 and outputs the boosted voltage. The backup power supply 4 is charged by the booster circuit 3. The IC 10 and the microcomputer 11 are supplied with electric power from the power supply circuit unit 50 for control, and begin operation. When the IC 10 operates, the microcomputer 11 will communicate with other control devices according to the CAN protocol and will exchange information. If the vehicle collides, the microcomputer 11 will output the ignition signal based on the output of the acceleration sensor. If the battery 2 is cut off, the output voltage of the booster circuit 3 will be interrupted. However, the IC 10 can operate without interruption since it is supplied with electric power from the backup power supply 4. The mode switching circuit unit 100 detects interruption of the output voltage of the booster circuit 3, and outputs the mode switching signal. The CAN transceiver circuit unit 54 then switches to the stand-by mode by receiving the mode switching signal, and halts output of the differential voltage signal. Therefore, the power consumption of the CAN transceiver circuit unit 54 is reduced, and the capacity of the backup power supply 4 can be reliably ensured. Moreover, the output of an unstable differential voltage signal can be prevented or reduced for example at the time of voltage lowering of the backup power supply 4. It should be noted that the ignition circuit unit 51 supplies the ignition current to the squib 6 based on electric power supplied from the backup power supply 4 and based on receiving the ignition signal. As described above, since the capacity of the backup power supply 4 is ensured, a sufficient ignition current to the squib 6 can be supplied. As will be appreciated, the squib 6 is ignited by the ignition current flowing thereinto, inflates the air bag, and protects the occupant of the vehicle safely.

Finally, an effect of the invention in accordance with the second and various exemplary embodiments will be explained. According to the second embodiment, in the backup state in which the output voltage of the booster circuit 3 is interrupted and the backup power supply 4 supplies electric power, the power consumption of the CAN transceiver circuit unit 54 can be suppressed. Therefore, the capacity of the backup power supply 4 can be ensured. Accordingly, it is possible to reliably set the air bag into operation.

Moreover, according to the second embodiment, the mode switching circuit unit 100 can be constructed with specific hardware so as to ensure that the mode switching signal can be reliably outputted.

It will be appreciated that in addition to the specific embodiments described above, additional embodiments are possible. For example, in accordance with the first exemplary embodiments as described above, the power supply interruption detection circuit unit 52 and the mode switching circuit unit 53 are described as being constructed with certain hardware components. Further, in the second embodiment, the mode switching circuit unit 100 is described as being constructed with certain hardware components. However, the specific construction of an exemplary circuit is not restricted by the above described embodiments. Rather, in accordance with various alternative exemplary embodiments, the standby operation control functions carried out by the above noted circuits may be constructed using, for example, a program consisting of instructions executing in a microcomputer with the same effect being obtained. Moreover, since the hardware circuits are unnecessary in such alternative exemplary embodiments, the cost and size of the air bag system can be reduced.

What is claimed is:

1. A communication device, comprising:
a power source;
a backup power source that is charged by the power source and, when the power source is interrupted, supplies electric power in place of the power source;
a conversion circuit unit that is connected to the power source and the backup power source, converts signal of different forms mutually, and, when receiving a mode switching signal, switches to a low power consumption mode in which the power consumption is lower;
mode switching means for, when detecting that the power source is interrupted, outputting the mode switching signal; and
a microcomputer for communicating with an external device through the conversion circuit unit according to a predetermined protocol.

2. The communication device according to claim 1,
wherein the conversion circuit unit converts a differential voltage signal and a digital signal mutually and the microcomputer communicates according to the CAN protocol.

3. The communication device according to claim 2,
wherein the mode switching means is constructed with a circuit.

4. The communication device according to claim 2,
wherein the mode switching means is constructed with a program in the microcomputer.

5. A communication device comprising:
a power supply;
a backup power supply that is charged by the power source and supplies electric power when the power supply is interrupted;
a conversion circuit unit that is connected to the power supply and the backup power supply, converts signals of different forms mutually, and, when receiving a mode switching signal, switches to a low power consumption mode in which power consumption is lower;
power supply interruption detecting means for, when detecting that the power supply is interrupted, outputting a first control signal;
a microcomputer for communicating with an external device through the conversion circuit unit according to a predetermined protocol and, when not using the conversion circuit unit, outputting a second control signal; and
mode switching means for, when at least either the first control signal or the second control signal is outputted, outputting the mode switching signal.

6. The communication device according to claim 5,
wherein the conversion circuit unit converts a differential voltage signal and a digital signal mutually, and the microcomputer communicates according to a CAN protocol.

7. The communication device according to claim 6,
wherein each of the power supply interruption detecting means and the mode switching means is constructed with a circuit.

8. The communication device according to claim 6,
wherein each of the power supply interruption detecting means and the mode switching means is constructed with a program in the microcomputer.

9. The communication device according to claim 1,
wherein the conversion circuit unit halts output of the differential voltage signal when the mode is switched to the low power consumption mode.

10. The communication device according to claim 1,
wherein the microcomputer controls a passive safety means connected to the power supply and the backup power supply.

11. A passive safety device, comprising:
a communication device according to claim 1; and
a passive safety means for vehicle that is connected to the power supply and the backup power supply and, when the power supply is interrupted, is driven by the backup power supply.

12. An integrated circuit (IC) for providing air bag control and for ensuring a capacity of a backup power supply in an air bag system, the air bag system including a battery, a power supply, a booster circuit, a microcomputer, and an air bag activation device, the IC comprising:
a communication unit connected to the power supply and the backup power supply, the communication unit communicating according to a CAN protocol; and
a power supply interruption detection unit detecting a power supply interruption and switching a mode of the communication unit,
wherein, when the booster circuit is interrupted, the power supply interruption detection circuit unit outputs a signal to change the mode of the communication unit to a stand-by mode to reduce power consumption of the communication unit to preserve a power supply of the backup power supply for reliably operating the air bag activation device.

13. The IC according to claim 12,
wherein the power supply interruption detection unit is constructed with a high reliability circuit.

14. The IC according to claim 12,
wherein the communication unit halts output of a differential voltage signal when the mode is switched to the standby mode.

15. The IC according to claim 12,
wherein the microcomputer is further coupled to the backup power supply and the IC, the microcomputer configured to control the activation of the airbag device.
